(19) United States
(12) Patent Application Publication
(10) Pub. No.: US 2006/0221924 A1
(43) Pub. Date: Oct. 5, 2006

(54) Mobile communications terminal for transmitting data frames in wireless lan and method thereof

(75) Inventors: Ji-Sung Yang, Seoul (KR); Baek-Ju Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/392,836

(22) Filed: Mar. 30, 2006

(30) Foreign Application Priority Data
Mar. 30, 2005 (KR) 26703/2005

(51) Int. Cl. H04J 1/16; H04Q 7/24

(52) U.S. Cl. 370/338; 370/252

(57) ABSTRACT

A mobile communications terminal for transmitting data frames via a mobile communications terminal in a wireless LAN and a method thereof, the method including: storing data frames to be transmitted in a memory and determining transmission of the stored data frames based on the number of the stored data frames; and consecutively transmitting the stored data frames in a burst to an AP (Access Point) when transmission of the stored data frames is determined and occupancy of a transmission channel is granted.

### BACKGROUND OF THE INVENTION

1. Field of the Invention

The present invention relates to a mobile communications terminal, and particularly, to a mobile communications terminal for transmitting data frames from a mobile communications terminal in a wireless LAN (Local Area Network) which can reduce the transmitting power consumption of the mobile communications terminal, and a method thereof.

2. Description of the Related Art

In general, a mobile communications terminal is a device which enables anywhere, anytime communication with another party by calling the other party by radio and being connected with the other party by radio through the switching control of a Mobile Switching Center (MSC) while moving within a service area of a Base Station (BS). Also, the mobile communications terminal allows data communication composed of symbols, numbers and characters and multimedia communications including image signals as well as voice communication.

When the mobile communications terminal is equipped with a wireless LAN module, implementation of a wireless LAN is increasingly becoming commonplace in everyday life. Since the wireless LAN does not require cable wiring work, network installation is easy, and very high speed data communication is possible by using wideband radio transmission.

Modes for implementing a wireless LAN are divided into an Ad-Hoc Mode used when transmitting data between mobile communications terminals only by a wireless LAN module and an Infrastructure mode using an AP (Access Point) serving as a bridge with an existing wired network. In particular, in the method using the AP, it is possible to mutually connect with a wired LAN, network connection is possible while moving, and security functions can be used.

The mobile communications terminal capable of transmitting and receiving data at a very high speed through a wireless LAN network is actively being developed. Hereinafter, a principle of transmitting a data frame via a mobile communications terminal in accordance with a related art will be described with reference to FIG. 1.

FIG. 1 is a diagram illustrating the principle of transmitting data frames via the mobile communications terminal in wireless LAN in accordance with the related art.

As illustrated in FIG. 1, a mobile communications terminal in accordance with the related art transmits a RTS (Request To Send) frame to an AP for requesting occupancy of a transmission channel for transmission of a data frame and receives a CTS (Clear to Send) frame from the AP for allowing the transmission of the data frame to thereby occupy the transmission channel. Thus, after waiting for a time interval of an SIFS (Short Inter Frame Space) via the occupied transmission channel, the mobile communications terminal transmits one data frame to the AP. Then, the AP receives the data frame, and transmits an ACK frame to the mobile communications terminal after waiting for the time interval of an SIFS.

In the wireless LAN according to the related art, the time interval between frames is called an IFS (Inter Frame Space). Four different IFSs are defined to provide priority levels for access to the wireless media: SIFS (Short Inter Frame Space), PIFS (PCF Inter Frame Space), DIFS (DCF Inter Frame Space) and EIFS (Extended Inter Frame Space).

However, the mobile communications terminal in accordance with the related art that transmits one data frame when granted permission for a transmission channel by the AP (Access Point) must transmit RTS and CTS frames every time in order to be granted permission for a transmission channel for transmitting one data frame. Thus, much transmitting power of the mobile communications terminal is required.

### BRIEF DESCRIPTION OF THE INVENTION

Therefore, it is an object of the present invention to provide a mobile communications terminal for transmitting data frames in a wireless LAN which can reduce the consumed transmitting power of the mobile communications terminal by consecutively transmitting a certain number of data frames when the mobile communications terminal is granted permission for a transmission channel from an AP (Access Point), and a method thereof.

To achieve these and other advantages and in accordance with the purpose of the present invention, as embodied and broadly described herein, there is provided a method for transmitting data frames via a mobile communications terminal in a wireless LAN, comprising; storing data frames to be transmitted in a memory and determining transmission of the stored data frames based on the number of the stored data frames; and transmitting the stored data frames to an AP (Access Point) when transmission of the stored data frames is determined.

According to another embodiment of the present invention, there is provided a method for transmitting data frames via a mobile communications terminal in a wireless LAN in which a mobile communications terminal transmits an RTS (Request To Send) frame to an AP (Access Point) and receives a CTS (Clear To Send) frame from the AP to thereby occupy a transmission channel, and thereafter transmits data frames, the method comprising: transmitting an N^{th} data frame to the AP by the mobile communications terminal based on the data frames stored in the memory; and receiving an N^{th} ACK frame with respect to the N^{th} data frame.

To achieve these and other advantages and in accordance with the purpose of the present invention, a mobile communications terminal for transmitting data frames in a wireless LAN can comprise: a controller for determining transmission of stored data frames based on the number of the stored data frames; and a transceiver for consecutively transmitting a certain number N of data frames to an Access Point (AP) when the stored data frames are determined to be transmitted.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram illustrating the principle of transmitting data frames via a mobile communications terminal in a wireless LAN in accordance with the related art;

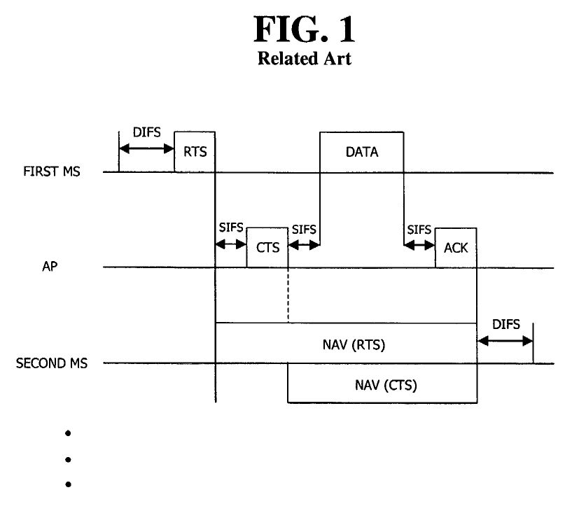

FIG. 2 is a block diagram illustrating a construction of a mobile communications terminal for transmitting data frames in a wireless LAN in accordance with the present invention;

FIG. 3 is a flowchart illustrating a method for transmitting data frames via the mobile communications terminal in a wireless LAN in accordance with the present invention; and

FIG. 4 is a diagram illustrating the principle of transmitting data frames via the mobile communication terminal in a wireless LAN in accordance with the present invention.

### DETAILED DESCRIPTION OF THE INVENTION

Hereinafter, a mobile communications terminal for transmitting a data frame in accordance with the present invention which can reduce transmitting power consumption by consecutively transmitting a certain number of data frames when granted permission for a transmission channel from an Access Point (AP) or Wireless Access Point (WAP) and a method thereof will be described with reference to the accompanying drawings.

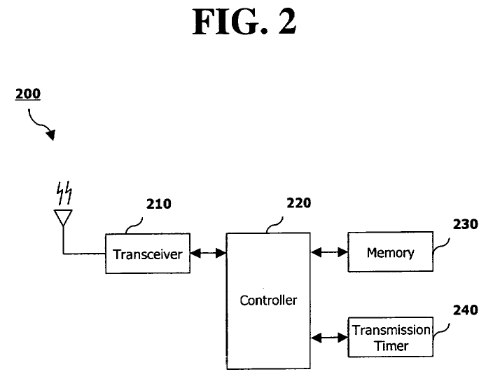

FIG. 2 is a block diagram illustrating a construction of a mobile communications terminal for transmitting data frames in a wireless LAN in accordance with the present invention.

As illustrated in FIG. 2, the mobile communications terminal for transmitting data frames in a wireless LAN according to the present invention may include a memory 230 for storing data frames to be transmitted, a controller 220 for determining transmission of the stored data frames based on the number of the stored data frames, a transceiver 210 for transmitting the data frames consecutively via using a fragmentation depending on the determining, and a transmission timer 240 which is operated when the data frames are stored and terminated when the data frames are transmitted.

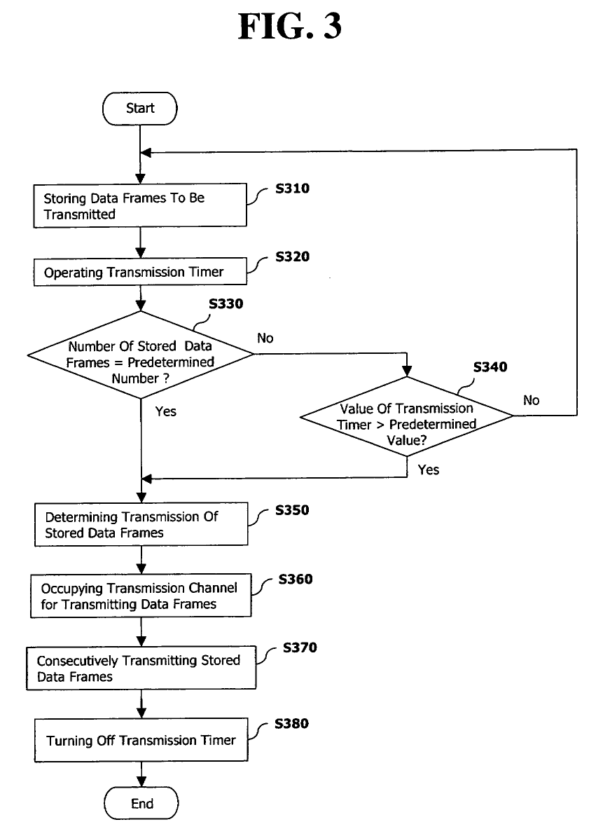

A method for transmitting data frames of the mobile communications terminal in the wireless LAN according to the present invention having such construction will now be explained with reference to FIG. 3.

FIG. 3 is a flowchart illustrating the method for transmitting data frames via a mobile communications terminal in a wireless LAN according to the present invention.

As illustrated in FIG. 3, the method for transmitting data frames via a mobile communications terminal in a wireless LAN in accordance with the present invention comprises: storing data frames to be transmitted in a memory (S310); operating a transmission timer when the data frames are stored (S320); checking whether or not the number of the stored data frames coincides with a certain number (S330); determining transmission of the stored data frames when the number of the stored data frames equals the certain number (S350); occupying a transmission channel when the transmission of the data frames is determined (S360); transmitting the stored data frames via the occupied transmission channel (S370); and turning off the transmission timer being operated when the data frames are transmitted (S380).

In case the number of the stored data frames does not equal the certain number at step S230, then the mobile communications terminal compares the value of the transmission timer being operated with a certain value (S340). If the value of the transmission timer is greater than the certain value, the mobile communications terminal determines to transmit the stored data frames. If the value of the transmission timer is less than the certain value, the mobile communications terminal continues to store the data frames to be transmitted.

The method for transmitting data frames via a mobile communications terminal in accordance with the present invention will now be described in more detail.

First, the mobile communications terminal 200 stores data frames to be transmitted in the memory 230 (S310) and operates the transmission timer 240 (S320). That is, the controller 220 can check whether or not the data frames continue to be stored in the memory 230 through the transmission timer 240 being operated. Here, the mobile communications terminal may be a mobile phone capable of mobile communication, a PDA (personal digital assistant) or a notebook PC.

The controller 220 compares the number of the stored data frames with the certain frame number (S330). That is, when the number of the stored data frames is greater than the certain number, the controller 220 determines transmission of the stored data frames.

On the other hand, when the number of the stored data frames is less than the certain number, the controller 220 compares a value of the transmission timer 240 with the certain threshold value (S340). That is, when the value of the transmission timer 240 is less than the certain threshold value, the data frames to be transmitted are continuously stored in the memory 230. When the value of the transmission timer 240 is greater than the certain threshold value, the controller 220 determines transmission of the stored data frames (S250).

By operating the transmission timer 240 and comparing the value of the transmission timer 240 with the certain threshold value, the mobile 10 communications terminal 200 can prevent a transmission delay of the stored data frames even though the number of the data frames stored in the memory 230 is not equal to the certain frame number when a data frame to be transmitted is only occasionally generated.

When the transmission of the stored data frames is determined, the mobile communications terminal 200 occupies a transmission channel for transmitting the stored data frames to the AP (S360). That is, the mobile communications terminal 200 transmits an RTS (Request to Send) frame for requesting transmission of the data frames to the AP, and the AP transmits a CTS (Clear To Send) frame for allowing the transmission of the data frames to the mobile communications terminal in response to the RTS frame.

Here, the RTS frame includes an address of the mobile communications terminal from which the data frames are to be transmitted and a duration frame used to set up a network allocation vector (NAV) for devices receiving the RTS. Accordingly, the AP having received the RTS frame transmits a CTS frame in response to the RTS frame. Other mobile communications terminals within the service area of the AP set their NAVs to values of duration fields included in the received RTS or CTS frames, respectively, and then wait for access to the AP while reducing their NAV values over time.

In addition, in the wireless LAN, the time interval between frames is called IFS (Inter Frame Space). Four different IFSs are defined to provide priority levels for access to the wireless media: SIFS (Short Inter Frame Space), PIFS (PCF Inter Frame Space), DIFS (DCF Inter Frame Space) and EIFS (Extended Inter Frame Space).

In particular, the SIFS is the shortest IFS, and is mainly used in an ACK frame, a CTS frame, consecutive fragmentation frames or the like.

Thereafter, the controller 220 transmits the data frames stored in its memory 230 in response to the received CTS message (S370), and turns off the transmission timer 240 being operated (S380).

For instance, a case that the mobile communications terminal transmits two data frames consecutively is described. After receiving the CTS message, the mobile communications terminal waits for a time interval of the SIFS and then transmits a first data frame to the AP. Then, the AP receives the first data frame, waits for the time interval of the SIFS, and then transmits a first ACK frame to the mobile communications terminal.

Hence, the mobile communications terminal receives the first ACK frame, waits for a time interval of the SIFS and then transmits a second data frame to the AP. Then the AP receives the second data frame, waits for the time interval of the SIFS and transmits a second ACK frame to the mobile communications terminal.

The mobile communications terminal can consecutively transmit the certain number of data frames by occupying the transmission channel once, and not by having to request before occupying the communication channel every time the mobile communications terminal transmits one more data frame. The principle of transmitting data frames via the mobile communications terminal in the wireless LAN in accordance with the present invention will be described with reference to FIG. 3.

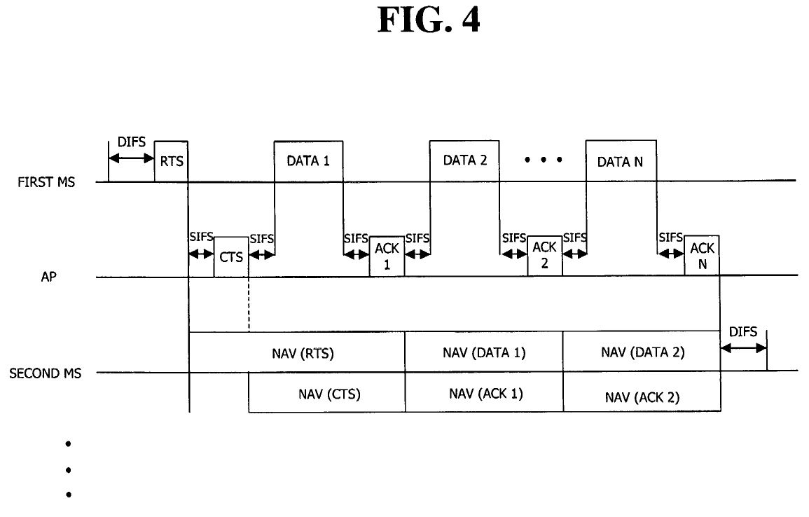

FIG. 4 is a diagram illustrating the principle of transmitting data frames via a mobile communication in the wireless LAN in accordance with the present invention.

As shown in FIG. 4, a mobile communications terminal in a wireless LAN transmits an RTS frame for requesting transmission of data frames and allows the transmission of the data frames to thereby occupy a transmission channel. Hence, the mobile communications terminal can consecutively transmit a certain number ‘N’ of data frames via the occupied transmission channel. That is, after waiting for a time interval of the SIFS (Short Inter Frame Space), the mobile communications terminal transmits the N^{th} data frame and receives an ACK message with respect to the N^{th} data frame. After the time interval of the SIFS, the mobile communications terminal can continue to transmit the N+1^{th} data frame. Here, the certain number N is previously set by a user and, preferably, is at least 1.

Thereafter, after transmission of the final data frame, when the AP is in an idle state during a time interval of the DIFS, the mobile communications terminal does not immediately connect to the AP but generates a random backoff time, and waits before any next access to the AP during the generated random backoff time. This is to reduce the probability of connection collisions between different mobile communications terminals intending to access the AP after the completing of transmission of the final data frame by the first mobile communications terminal.

At this time, the mobile communications terminal generated the shortest random backoff time accesses the AP successfully and therefore transmits an RTS frame. Every frame includes a duration field. The other mobile communications terminals update their NAV value only when receiving the duration field having a value greater than their present NAV. Accordingly, when the NAV value becomes zero, the mobile communications terminal determines that the AP is in an idle state, waits during the time interval of the DIFS, and then tries connection to the AP, reducing its random backoff time.

As described so far, the method for transmitting data frames via a mobile communications terminal in a wireless LAN in accordance with the present invention can reduce transmitting power consumption of the mobile communications terminal because unnecessary transmission of RTS and CTS frames for occupying a transmission channel each time the mobile communications terminal wishes to transmit one data frame is reduced by consecutively transmitting a certain number of data frames when the mobile communications terminal is granted permission for the transmission channel from an AP.

In accordance with the present invention, a system for transmitting data frames via a mobile communications terminal in a wireless LAN in which a mobile communications terminal transmits an RTS (Request To Send) frame to an AP (Access Point) and receives a CTS (Clear To Send) frame from the AP to thereby occupy a transmission channel, and thereupon transmits data frames, the system may comprises a first mobile communications terminal comprising, a memory to store data frames to be transmitted, a controller for determining transmission of stored data frames based on the number of the stored data frames, and a transceiver for transmitting an N^{th} data frame to the AP by the mobile communications terminal based on the number of data frames stored in a memory; and the Access Point (AP) to receiving the N^{th} data frame from the mobile terminal and transmitting an N^{th} ACK frame to the mobile terminal with respect to the N^{th} data frame.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for transmitting data frames via a mobile communications terminal in a wireless LAN, comprising;
storing data frames to be transmitted in a memory;
determining transmission of the stored data frames based on the number of the stored data frames; and
transmitting the stored data frames to an AP (Access Point) consecutively depending on the determining.

2. The method of claim 1, wherein the determining of transmission of the stored data frames comprises:
checking whether the number of the stored data frames is equal to a certain frame number; and
determining transmission of the stored data frames if the number of the stored data frames is equal to the certain frame number.

3. The method of claim 2, wherein the certain frame number is previously set by a user.

4. The method of claim 2, further comprising:
operating a transmission timer when the data frames are stored;
comparing a value of the transmission timer with a certain threshold value if the number of the stored data frames is less than the certain frame number; and
determining transmission of the stored data frames when the value of the transmission timer is greater than the certain threshold value.

5. The method of claim 4, wherein the data frames to be transmitted are continuously stored in the memory when the value of the transmission timer is less than the certain threshold value.

6. The method of claim 1, wherein the transmitting of the stored data frames to the AP comprises:
occupying a transmission channel for transmitting the stored data frames; and
transmitting the stored data frames consecutively to the AP via the occupied transmission channel in a burst.

7. The method of claim 6, wherein the occupying of the transmission channel comprises:
transmitting an RTS (Request To Send) frame to the AP for requesting transmission of the data frames; and
occupying the transmission channel upon receiving a CTS (Clear To Send) frame from the AP in response to the transmitted RTS frame.

8. A method for transmitting data frames via a mobile communications terminal in a wireless LAN in which a mobile communications terminal transmits an RTS (Request To Send) frame to an AP (Access Point) and receives a CTS (Clear To Send) frame from the AP to thereby occupy a transmission channel, and thereupon transmits data frames, the method comprising:
transmitting an N^{th} data frame to the AP by the mobile communications terminal based on the number of data frames stored in a memory; and
receiving an N^{th} ACK frame with respect to the N^{th} data frame.

9. The method of claim 8, wherein the RTS frame includes an address of the mobile communications terminal and a duration field for setting up a network allocation vector (NAV).

10. The method of claim 8, wherein a time interval between the RTS frame and the CTS frame is a Short Inter Frame Short Inter Frame Space (SIFS) period.

11. The method of claim 8, wherein a time interval between the CTS frame and a first data frame is a Short Inter Frame Space (SIFS) period.

12. The method of claim 8, wherein a value of N comprises at least 1.

13. The method of claim 12, wherein the value of N is previously set by a user.

14. The method of claim 8, wherein a time interval between the transmitted N^{th} data frame and the N^{th} ACK frame is a time interval of an SIFS (Short Inter Frame Space).

15. The method of claim 8, wherein a time interval between the N^{th} ACK frame and an N+1^{th} data frame to be transmitted is a time interval of an SIFS (Short Inter Frame Space).

16. The method of claim 8, wherein the mobile communications terminal is one of a mobile phone, a personal digital assistant (PDA) and a notebook personal computer.

17. A mobile communications terminal for transmitting data frames in a wireless LAN comprising:
a memory to store data frames to be transmitted;
a controller for determining transmission of stored data frames based on the number of the stored data frames; and
a transceiver for transmitting a certain number N of data frames consecutively when the stored data frames are determined to be transmitted.

18. The terminal of claim 17, further comprising a transmission timer which is operated when the data frames are stored and is terminated when the data frames are transmitted.

19. The terminal of claim 18, wherein the controller cooperating with the transmission timer, the memory and the transceiver is adapted to perform,
checking whether the number of the stored data frames is equal to a certain frame number; and
transmitting the stored data frames if the number of the stored data frames is equal to the certain frame number.

20. The terminal of claim 18, wherein the controller cooperating with the transmission timer, the memory and the transceiver is adapted to perform,
comparing a value of the transmission timer with a certain threshold value if the number of the stored data frames is less than the certain frame number; and
transmitting stored data frames when the value of the transmission timer is greater than the certain threshold value.

21. The terminal of claim 20, wherein the memory stores the data frames to be transmitted when the value of the transmission timer is less than the certain threshold value.

22. The terminal of claim 18, wherein the controller cooperating with the transceiver, the transmission timer and the memory is adapted to perform,
transmitting an RTS (Request To Send) frame to the AP for requesting transmission of the data frames;
occupying the transmission channel upon receiving a CTS (Clear To Send) frame from the AP in response to the transmitted RTS frame; and
transmitting the stored data frames consecutively to the AP via the occupied transmission channel in a burst.

23. A system for transmitting data frames via a mobile communications terminal in a wireless LAN in which a mobile communications terminal transmits an RTS (Request To Send) frame to an AP (Access Point) and receives a CTS (Clear To Send) frame from the AP to thereby occupy a transmission channel, and thereupon transmits data frames, the system comprising:
a first mobile communications terminal comprising,
a memory to store data frames to be transmitted,
a controller for determining transmission of stored data frames based on the number of the stored data frames, and
a transceiver for transmitting an N^{th} data frame to the AP by the mobile communications terminal based on the number of data frames stored in a memory; and
the Access Point (AP) to receiving the N^{th} data frame from the mobile terminal and transmitting an N^{th} ACK frame to the mobile terminal with respect to the N^{th} data frame.

24. The system of claim 23, the system further comprises a second mobile communications terminal that is located within a service area of the AP and accesses the AP.

25. The system of claim 24, wherein at least one of the first and second mobile terminals generates a random backoff time after transmission of a final data frame, and holds an access to the AP during the generated random backoff time.

26. The system of claim 25, wherein the at least one of the first and second mobile communications terminals generated a shortest random backoff time accesses the AP and transmits the RTS frame having a duration field, and the other mobile communications terminal updates a network allocation vector (NAV) value only when receiving the duration field having a value greater than a present NAV.

27. The system of claim 26, wherein the other mobile communications terminal determines that the AP is in an idle state when the NAV value becomes zero, waits during the time interval of a DCF Inter Frame Space (DIFS), and accesses the AP for connection.
